(19) United States
(12) Patent Application Publication
(10) Pub. No.: US 2025/0314271 A1
(43) Pub. Date: Oct. 9, 2025

(54) ROLLING BEARING

(71) Applicant: Liebherr-Components Biberach GmbH, Biberach an der Riss (DE)

(72) Inventors: Markus RUF, Bad Waldsee (DE); Thomas ALTMAYER, Gutenzell-Hürbel (DE); Andreas PALMER, Riedlingen (DE)

(73) Assignee: Liebherr-Components Biberach GmbH, Biberach an der Riss (DE)

(21) Appl. No.: 19/244,932

(22) Filed: Jun. 20, 2025

Related U.S. Application Data
(63) Continuation of application No. PCT/EP2023/086417, filed on Dec. 18, 2023.

(30) Foreign Application Priority Data
Dec. 20, 2022 (DE) 20 2022 107 113.6

(51) Int. Cl. F16C 33/46; F16C 19/36; F16C 33/36

(52) U.S. Cl. CPC F16C 33/4676; F16C 19/364; F16C 33/366

(57) ABSTRACT

The present invention relates to a rolling bearing, preferably a centreless large roller bearing, comprising two concentric bearing rings which can rotate relative to one another, at least one row of rolling elements which support the bearing rings against one another and roll on raceways of the bearing rings, and a cage with separators between the rolling elements for separating and guiding the rolling elements, the separators being positioned eccentrically offset relative to one of the raceways with respect to a bearing clearance central axis along which the rolling elements are arranged in such a way that their axes of rotation are distributed relative to one another.

### CROSS-REFERENCE TO RELATED APPLICATIONS

This application is a continuation of International Patent Application Number PCT/EP2023/086417 filed Dec. 18, 2023, which claims priority to German Patent Application Number DE 20 2022 107 113.6 filed Dec. 20, 2022, which are incorporated herein by reference in their entireties.

### BACKGROUND

The present invention relates to rolling bearings comprising two concentric bearing rings which can rotate relative to one another, at least one row of rolling elements which support the bearing rings against one another and roll on raceways of the bearing rings, and a cage with separators between the rolling elements for separating and guiding the rolling elements.

Such rolling bearings can be, for example, large roller bearings, in particular centerless large roller bearings, which can have ring diameters of more than 0.5 or more than 1 m or even more than 2 m, wherein such large roller bearings can be used, for example, in wind turbines to support the rotor hub or to support the rotor blades on the rotor hub. Such large-diameter antifriction bearings can be designed with one or more rows and comprise radial and/or axial bearing rows.

Such rolling bearings can also be single-row tapered roller bearings. Alternatively, such bearings can also be multi-row tapered roller bearings or have other rolling elements, for example in the form of balls, cylindrical rollers or fir rollers or mixed forms in the sense of bearing rows consisting of different rolling element forms.

With such rolling bearings, one aim is to accommodate the largest possible number of rolling elements in a bearing row with a ring diameter that is usually predetermined due to the installation environment, in order to distribute the sometimes high loads over as many rolling elements as possible and to achieve an overall rigid bearing arrangement. For example, centerless large roller bearings are often subject not only to high forces but also to high bending moments, for example when used as rotor blade bearings on a wind turbine or as slewing ring bearings on a crane, so that the bearing rings tend to twist and the rolling elements in one sector are subjected to very high loads and can lift off in an opposite sector.

However, a densely packed arrangement of the rolling elements with a high number of rolling elements in a bearing row sometimes makes mounting more difficult. It is also sometimes difficult to accommodate the bearing cage, which holds the rolling elements at a distance and guides them along the raceways on the bearing rings during rolling, especially if the rolling elements are to be guided at a short distance from each other in order to accommodate a high number of rolling elements.

A tightly packed arrangement of the rolling elements with small distances between the rolling elements can also impair the stability or rigidity of the cage, as the separators between the rolling elements must be designed to be correspondingly narrow or thin-walled in order to allow small distances between the rolling elements.

Against this background, it is the task of the present invention to provide an improved rolling bearing of said type which avoids the disadvantages of the prior art and further develops the latter in an advantageous manner. In particular, the number of rolling elements in a bearing series should be as high as possible without sacrificing case of assembly and sufficient rigidity of the cage.

### SUMMARY

According to the invention, said problem is solved by a rolling bearing according to claim 1. Preferred embodiments of the invention are the subject-matter of the dependent claims.

It is therefore proposed to position the separators of the cage eccentrically and no longer to arrange them exactly at the level of the axes of rotation of the rolling elements. According to the invention, the separators are arranged eccentrically offset relative to one of the raceways with respect to a center axis of the bearing clearance, along which the rolling elements are positioned with their axes of rotation.

Due to the eccentrically offset arrangement of the separators, they are no longer positioned at an equal distance from the two raceways on which the rolling elements roll, but are positioned closer to one raceway. The distance of the separators from one of the two raceways is smaller than the distance of the separators from the other of the two raceways.

The eccentrically offset arrangement of the separators means that they are located in an area between two rolling elements with more space, so that the separators can be sufficiently dimensioned even if the rolling elements are closely packed. The rolling elements have the smallest distance from each other at the level of the rolling element axes of rotation, while the space between two rolling elements widens from the bearing clearance central axis towards both raceways, so that the separators come to lie in the widening area due to the eccentrically offset arrangement. At the same time, the eccentrically offset arrangement allows the separators to hold the rolling elements on one of the bearing rings during assembly or disassembly of the rolling element, in particular on the raceway from which the separators are spaced further apart.

In a further development of the invention, the distance of the separators from one of the raceways can be more than 150% or even more than 200% of the distance from the other raceway.

In particular, the separators can be positioned at approximately ⅔ to approximately ¾ of the clear height of the bearing clearance between the two raceways. The clear height refers to the distance between the two raceways, measured in a direction perpendicular to the axis of rotation of a rolling element. In the case of raceways that are inclined to each other, such as the raceways of a tapered rollers bearing series, the distance can be measured, for example, perpendicular to the rolling bearing axis of rotation in the center of the rolling elements.

The separators can advantageously have a circular cross-section and a substantially constant diameter over their length, so that the separators can form cylindrical rods overall. Alternatively, however, the separators can also have a diameter or thickness that deviates over their length, for example continuously increasing in thickness or diameter from one axial end to the opposite axial end. If the separators have a circular cross-section, the separators can have a slightly conical shape when viewed as a whole.

However, the separators can also have a cross-section that deviates from the circular shape, for example a trapezoidal, triangular, polygonal or polygonal contour when viewed in cross-section. Viewed over their length, the separators can have a constant diameter or a changing diameter, for example continuously increasing in diameter from one axial end to the opposite axial end.

Depending on the shape of the rolling element, the separators can also have other contours, for example a contour similar to that of an hourglass, and can thicken from a thin central section towards both axial ends, for example if balls or barrels are used as rolling elements.

In an advantageous further development of the invention, the separators are adapted in their contour to the contour of the rolling elements to be guided in order to achieve the desired contact geometry and the desired friction behavior between the rolling elements and the cage or separators.

Regardless of the contouring of the separators, the cage can be designed to hold the rolling elements with the separators on one of the bearing rings, so that said bearing ring together with the rolling elements and the cage forms a pre-assembled mounting assembly. The cage with the separators holds the rolling elements or the roller set on the respective bearing ring, so that the bearing ring together with the bearing row can be handled as a unit without the rolling elements being able to fall off the bearing ring, even if the bearing has been dismantled or has not yet been joined to the other bearing ring.

In a further development of the invention, the raceway of the bearing ring, on which the roller set is held by the cage, can be recessed in the form of a groove or laterally enclosed by projecting side walls or guide projections, so that the rolling elements cannot slip off the raceway in the direction of their axis of rotation when they are held on the raceway by the separators. Depending on the contouring of the rolling elements, said raceway can also be recessed in the shape of a channel or be harmoniously curved when viewed in cross-section, for example when using balls or barrels contoured in the shape of a ball, so that the rolling elements, when held on the raceway by the cage, can also not slide off the raceway transversely, i.e. in the direction of the axes of rotation.

In a further development of the invention, the two raceways can have different track diameters and the separators can be spaced further apart from the raceway with the smaller track diameter than from the raceway with the larger track diameter.

In particular, the cage can hold the rolling elements of a bearing row on the inner ring. The separators can be positioned closer to the outer ring raceway and spaced further apart from the inner ring raceway so that the eccentrically positioned separators can hold the rolling elements on the inner ring.

To enable easy assembly, the cage can be of differential design.

For example, the separators can be mounted or fastened to at least one cage ring that extends along the bearing clearance. In particular, the cage may comprise two cage rings to which the separators are mounted or fastened with opposite axial ends and which are connected to each other by said separators.

For example, the separators can be joined to the at least one cage ring by a suitable joining process, whereby, for example, a plug connection or a detachable fastening of the separators to the cage ring can be provided.

In a further development of the invention, the separators can be joined to the cage rings while the rolling elements are already resting on the race and the separators are positioned between adjacent rolling elements. This simplifies assembly considerably.

Once the separators have been installed and connected to the cage rings, the rolling element set forms a functional unit together with the cage and the bearing ring, in which the rolling elements are held on the bearing ring.

The cage can be guided by the rolling elements or one of the bearing rings, for example the inner ring or the outer ring, or by both bearing rings or by a combination of said assemblies, for example by the rolling elements and one of the bearing rings, for example the inner ring.

### BRIEF DESCRIPTION OF THE DRAWINGS

The invention is explained in more detail below using a preferred exemplary embodiment and corresponding drawings. The drawings show:

FIG. 1: a sectional view of a rolling bearing according to an advantageous embodiment of the invention, wherein a half-section through the axis of rotation of a rolling element is shown, which illustrates the eccentrically offset arrangement of the separators of the cage,

FIG. 2: a perspective sectional view through the pre-assembled functional unit comprising the inner ring, the roller set and the cage of the rolling bearing from FIG. 1, wherein the holding function of the cage, which holds the roller set on the inner ring, is illustrated,

FIG. 3: a perspective view of the rolling element set together with the cage, which illustrates the arrangement of the separators relative to the rolling elements,

FIG. 4: a perspective view of the roller set together with the cage from the previous figures, and

FIG. 5: a perspective view of the cage without rollers.

### DETAILED DESCRIPTION

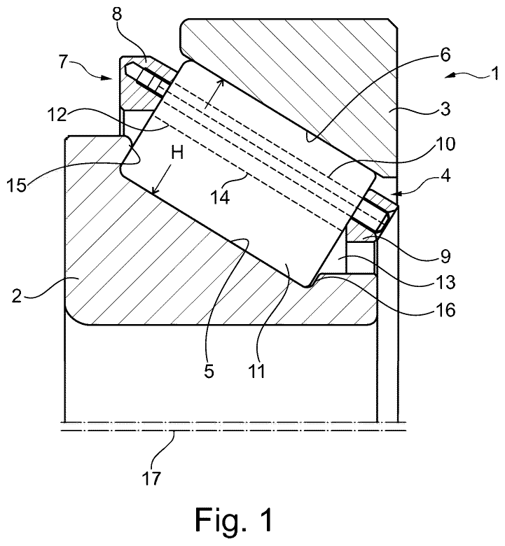

As shown in FIG. 1, the rolling bearing 1 can have a single-row design, for example in the form of a tapered roller bearing or an angular contact cylindrical roller bearing. However, the bearing can also be designed with two or more rows and have one or more radial bearing rows and/or one or more axial bearing rows.

As shown in FIG. 1, the rolling bearing comprises two bearing rings 2 and 3, of which one bearing ring can form an inner ring 2 and the other bearing ring can form an outer ring 3. The bearing rings can be formed in one piece or in several pieces, for example segmented or divided.

As shown in FIG. 1, the rolling elements 11 of the rolling element bearing row 4 run on the raceways 5 and 6 of the bearing rings 2 and 3, so that the bearing rings 2 and 3 can rotate relative to one another and are supported against one another by the rolling element bearing row 4.

The raceways 5 and 6 can be inclined at an acute angle to the axis of rotation 17 of the bearing rings 2, 3, so that a main bearing direction perpendicular to the axis of rotation 12 of the rolling elements 11 comprises both a radial component and an axial component.

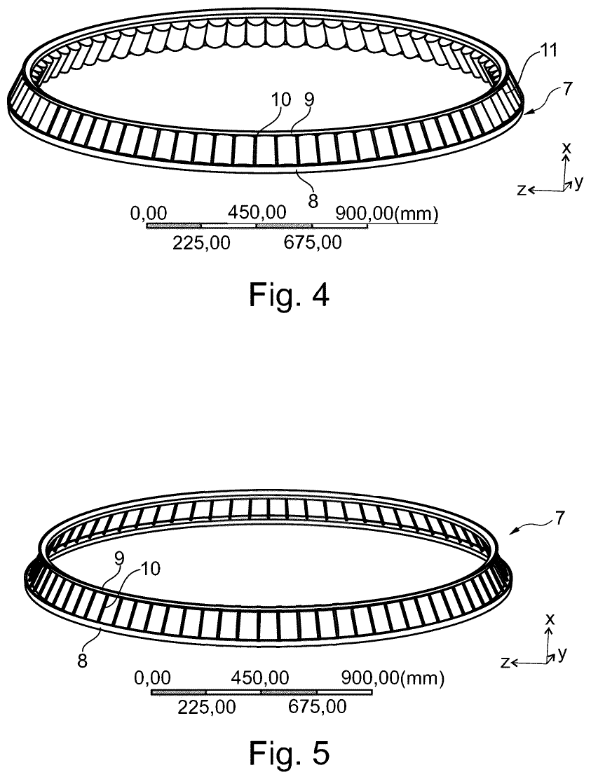

As the figures show, the rolling elements 11 of the bearing series 4 are guided by a cage 7 and held at a distance from one another, the cage 7 comprising a plurality of separators 10, each of which extends between two adjacent rolling elements 11, cf. FIGS. 3 and 4.

Said separators 10 can be contoured in the form of elongated rod profiles and have a cylindrical shape, for example.

Irrespective thereof, the separators 10 can extend between two cage rings 8 and 9 and connect them to each other. The separators 10 can be fastened to the cage rings 8 and 9 by a suitable joining process, whereby, for example, the cage rings 8 and 9 can have plug-in recesses into which the separators 10 can be inserted, cf. FIG. 1.

Said cage rings 8 and 9 can extend on opposite sides of the rolling elements 11, in particular on opposite end-faces, at which the axes of rotation 12 of the rolling elements 11 emerge from the latter, cf. FIG. 1.

As FIGS. 1 and 3 show, the separators 10 are positioned eccentrically offset with respect to the center axis 14 of the bearing clearance 13 towards one of the raceways 6. In particular, the separators 10 can be positioned offset towards the outer ring 3, so that the distance of the separators 10 from the outer ring raceway 6 is smaller than the distance from the inner ring raceway 5.

For example, the separators 10 can be positioned at approximately ⅔ to ¾ of the clear height of the bearing clearance 13, cf. FIG. 1.

Due to this eccentrically offset arrangement of the separators 10, the latter have more space between the adjacent rolling elements 11 on the one hand, as they are no longer positioned in the area of the smallest gap dimension between two adjacent rolling elements 11. The smallest gap dimension between two adjacent rolling elements 11 is present in the area of the bearing clearance central axis 14, which is positioned approximately centrally between the raceways 5 and 6 and along which the axes of rotation 12 of the rolling elements 11 move when the rolling elements 11 roll on the raceways 5, 6. The rolling elements 11 come closest to each other at the level of the axes of rotation 12.

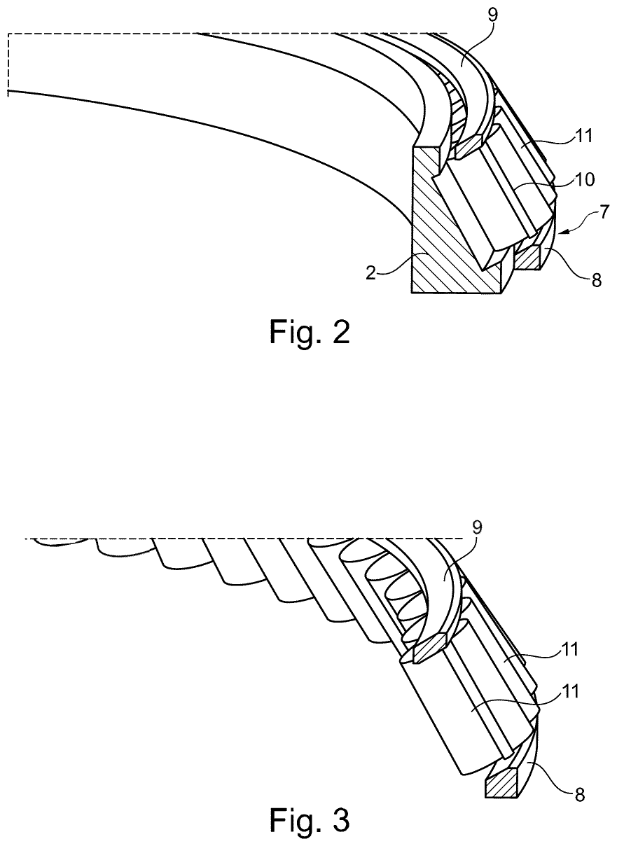

On the other hand, the cage 7 with the separators 10 can hold the rolling elements of the bearing row 4 on one of the bearing rings 2, 3, in particular on the inner ring 2, so that the inner ring 2 together with the roller set and the cage 7 can form a pre-assembled functional unit, as shown in FIG. 2.

Advantageously, the raceway 5 of the bearing ring 2, in particular of the inner ring 2, on which the roller set is held by the cage 7, can be contoured in the form of a groove and/or can be enclosed laterally by guide projections 15, 16, whereby the raceway 5 can also be contoured in the form of a groove depending on the contouring of the rolling elements 11. Due to the channel-shaped contouring or the lateral enclosure by guide projections 15, 16, the rolling elements 11 cannot slide laterally off the bearing ring 2 in the pre-assembled state according to FIG. 2. Alternatively, or additionally, a guide contour could also be provided on one or both cage rings 8, 9 in order to prevent the inner ring 2 and/or the outer ring 3 from slipping out axially.

As shown in FIG. 5, the cage 7 as a whole can define a tapered envelope contour, whereby a tapered envelope contour can be applied to the cage 7 on the inner surface side as well as on the outer surface side.

As can be seen from the drawings, the rolling bearing 1 is characterized by the following aspects:

First of all, it is provided that the separators 10 are positioned eccentrically offset with respect to the center axis 14 of the bearing clearance 13 and/or with respect to the axes of rotation 12 of the rolling elements 11 towards one of the raceways 6.

In this respect, it may be provided that the distance of the separators 10 from the raceway 5 of the inner ring 2 is at least 150% or at least 200% of the distance of the separators from the raceway 6 of the outer ring 3.

In particular, the separators 10 may be positioned approximately at ⅔ to ¾ of the clear height H of the bearing clearance 13 between the two raceways 5, 6.

Furthermore, it can be provided that the rolling elements 11 are held by the cage 7 with the separators 10 on one of the bearing rings 2, so that said bearing ring 2, the rolling elements 11 and the cage 7 with the separators 10 form a pre-assembled mounting assembly.

Furthermore, it can be provided that the raceway 5 of the bearing ring 2, on which the rolling elements 11 are held pre-assembled by the cage 7 with the separators 10, is in the form of a groove and/or is laterally enclosed by guide projections 15, 16.

Furthermore, it may be provided that the two raceways 5, 6 have different track diameters and that the separators 10 are arranged at a greater distance from the raceway 5 with the smaller track diameter than from the raceway 6 with the larger track diameter.

Furthermore, it can be provided that one of the bearing rings 2 forms an inner ring and the other bearing ring 3 forms an outer ring, with the separators 10 being spaced further apart from the raceway 5 of the inner ring 2 than from the raceway 6 of the outer ring 3 and holding the rolling elements 11 on said inner ring.

Furthermore, it can be provided that the cage 7 has at least one cage ring 8, 9 to which the separators 10 are fastened, a mountable joint separation point being provided between the cage ring 8, 9 and the separators 10.

Furthermore, it can be provided that a detachable fastening or a plug connection is provided between the cage ring 8, 9 and the separators 10.

Furthermore, it can be provided that the separators 10 have a circular cross-section.

Furthermore, it can be provided that the separators 10 have a cross-section that deviates from the circular shape, in particular a trapezoidal, triangular or polygonal cross-section.

Furthermore, it can be provided that the separators 10 have a substantially constant diameter or a substantially constant thickness over their length.

Furthermore, it can be provided that the separators 10 have a deviating diameter over their length, in particular that they become continuously thicker towards one end-face. Furthermore, it can be provided that the rolling elements 11 are tapered rollers and/or the rolling bearing is designed as a single-row tapered roller bearing.

Furthermore, it can be provided that the cage 7 with its separators 10 defines a tapered envelope contour.

We claim:

1. A centreless large roller bearing comprising:
two concentric bearing rings rotatable relative to one another,
at least one row of rolling elements which support the bearing rings against one another and roll on raceways of the bearing rings and a cage with separators between the rolling elements for separating and guiding the rolling elements,
wherein the separators are eccentrically offset relative to one of the raceways with respect to a bearing clearance central axis along which the rolling elements are arranged such that their axes of rotation are distributed relative to one another.

2. The rolling bearing of claim 1, wherein a distance between the separators and one of the raceways is at least 150% or at least 200% of the distance between the separators and the other raceway.

3. The rolling bearing of claim 1, wherein the separators are at ⅔ to ¾ of the clear height of the bearing clearance between the two raceways.

4. The rolling bearing of claim 3, wherein the rolling elements are held by the cage with the separators on one of the bearing rings, so that the bearing ring, the rolling elements, and the cage with the separators form a pre-assembled mounting assembly.

5. The rolling bearing of claim 4, wherein the raceway of the bearing ring, on which the rolling elements are held pre-assembled by the cage with the separators, comprises a groove and/or is laterally enclosed by guide projections.

6. The rolling bearing of claim 1, wherein the two raceways have different track diameters and the separators are further away from the raceway with the smaller track diameter than from the raceway with the larger track diameter.

7. The rolling bearing of claim 1, wherein one of the bearing rings forms an inner ring and the other bearing ring forms an outer ring, wherein the separators are spaced further away from the raceway of the inner ring than from the raceway of the outer ring and hold the rolling elements on the inner ring.

8. The rolling bearing of claim 1, wherein the cage comprises at least one cage ring to which the separators are fastened, and wherein a mountable joint separation point is between the cage ring and the separators.

9. The rolling bearing of claim 8, wherein a detachable fastening or a plug connection is between the cage ring and the separators.

10. The rolling bearing of claim 1, wherein the separators have a circular cross-section.

11. The rolling bearing of claim 1, wherein the separators have a cross-section deviating from the circular shape, in particular a trapezoidal or triangular or polygonal cross-section.

12. The rolling bearing of claim 1, wherein the separators have a constant diameter or a constant thickness over their length.

13. The rolling bearing of claim 1, wherein the separators have a deviating diameter over their length.

14. The rolling bearing of claim 13, wherein the separators become continuously thicker towards one end-face.

15. The rolling bearing according to claim 1, wherein the rolling elements are tapered rollers and/or the rolling bearing is a single-row tapered roller bearing.

16. The rolling bearing of claim 1, wherein the cage with its separators defines a tapered envelope contour.
